(19) United States
(12) Patent Application Publication
(10) Pub. No.: US 2018/0291993 A1
(43) Pub. Date: Oct. 11, 2018

(54) TRANSMISSION DEVICE

(71) Applicant: MUSASHI SEIMITSU INDUSTRY CO., LTD., TOYOHASHI-SHI, AICHI (JP)

(72) Inventor: Shohei SAKATA, TOYOHASHI-SHI (JP)

(21) Appl. No.: 15/578,015

(22) PCT Filed: Jun. 6, 2016
(86) PCT No.: PCT/JP2016/066718

§ 371 Date: Nov. 29, 2017

(30) Foreign Application Priority Data
Jun. 8, 2015 (JP) 2015-115526

(51) Int. Cl. F16H 48/14

(52) U.S. Cl. CPC F16H 48/147

(57) ABSTRACT

A transmission device includes first and second rotation transmission members capable of relative rotation around a first rotary axis. A first eccentric unit is rotatably supported on an eccentric shaft portion on a second rotary axis eccentric to a main shaft portion of an eccentric shaft. A counterweight incapable of relative rotation with respect to the eccentric shaft is arranged between the first eccentric unit and a second rotation transmission member connected to the first eccentric unit. The orbit of the counterweight overlaps a portion of the orbits of multiple intermediate members, the orbits of which are defined by groove parts formed on the opposing surfaces of the first rotation transmission member and the first eccentric unit, and the opposing surfaces of the second rotation transmission member and the second eccentric unit, or, the orbit of the counterweight is outside of the orbits of the intermediate members.

The present invention relates to a transmission device applicable to a vehicle and, more particularly, to a transmission device that can be applied also as a differential device.

### BACKGROUND ART

A known arrangement of a transmission device includes, as disclosed in Patent Documents 1 to 3, a first rotation transmission member, a second rotation transmission member, an eccentric shaft, and an eccentric unit. More specifically, the first rotation transmission member and the second rotation transmission member are capable of relative rotation about a first rotary axis. The eccentric shaft includes a main shaft portion and an eccentric shaft portion. The main shaft portion extends along the first rotary axis. The eccentric shaft portion extends along a second rotary axis that is eccentric with respect to the first rotary axis. The eccentric shaft portion is capable of revolving about the first rotary axis. The eccentric unit is rotatably supported on the eccentric shaft portion so as to be capable of revolving about the first rotary axis while rotating around the second rotary axis. The eccentric unit is capable of mutually transmitting rotation between the first and second rotation transmission members. The first and second rotation transmission members, and the eccentric unit each have an opposing face that faces each other. At least one of the opposing faces has a groove portion formed therein and includes a plurality of intermediate members having an orbit restricted by the groove portion. The transmission device outputs, with reduced speed, from a second shaft connected integrally with the second rotation transmission member rotation input from a first shaft connected integrally with the eccentric shaft.

### PRIOR ART DOCUMENTS

### Patent Documents

Patent Document 1: Japanese Patent No. 4172516

Patent Document 2: Japanese Patent Application Laid-open No. 9-26011

Patent Document 3: Japanese Patent No. 4814351

### SUMMARY OF THE INVENTION

### Problems to Be Solved By the Invention

While the transmission devices disclosed in Patent Documents 1 to 3 are each to output from the second shaft via the eccentric unit supported on the eccentric shaft portion of the eccentric shaft the rotation input from the first shaft, the transmission devices disclosed in Patent Documents 1 and 2 each do not include a counterweight for preventing the eccentric shaft from whirling. Thus, eccentric loading occurs on the eccentric shaft and the eccentric shaft rotates unsteadily.

The transmission device disclosed in Patent Document 3 includes the eccentric weight 12c that serves as a counterweight, but that is disposed inside the first rollable balls 10 as the intermediate member between the stationary disc 3 and the eccentric disc 4. Thus, because of a need involved to avoid interference between the eccentric weight 12c and the first rollable balls 10, the eccentric weight 12c was not allowed to protrude largely outwardly in the radial direction of the eccentric shaft 12 as an eccentric shaft. As a result, the weight of the eccentric weight 12c was required to be increased in order to achieve moment balance with the eccentric portion 12d.

The present invention has been accomplished in light of such circumstances and it is an object thereof to provide a transmission device capable of preventing an eccentric shaft from whirling, while achieving reduction in weight.

### Means for Solving the Problems

In order to attain the above object, according to an aspect of the present invention, there is provided a transmission device comprising: a first rotation transmission member and a second rotation transmission member which are capable of relative rotation about a first rotary axis; an eccentric shaft including a main shaft portion on the first rotary axis and an eccentric shaft portion on a second rotary axis disposed eccentrically with respect to the first rotary axis, the eccentric shaft portion being capable of revolving about the first rotary axis; a first eccentric unit supported rotatably on the eccentric shaft portion, the first eccentric unit being capable of revolving about the first rotary axis while rotating around the second rotary axis and being capable of mutually transmitting rotation between the first eccentric unit and the first rotation transmission member; a second eccentric unit connected with the first eccentric unit via a connecting member, the second eccentric unit being capable of revolving about the first rotary axis while rotating, integrally with the first eccentric unit, around the second rotary axis and being capable of mutually transmitting rotation between the second eccentric unit and the second rotation transmission member; and a counterweight disposed between the first eccentric unit and the second eccentric unit, the counterweight being incapable of relative rotation with respect to the eccentric shaft, wherein at least one of the first rotation transmission member and the first eccentric unit or of the second rotation transmission member and the second eccentric unit has a groove portion formed in at least one of two opposing surfaces thereof and includes a plurality of intermediate members having orbits restricted by the groove portion, and the counterweight has an orbit disposed, when viewed from a direction of the first rotary axis, outside the orbits of the intermediate members or has only a part of the orbit disposed to overlap the orbits of the intermediate members. (This is a first aspect.)

Further, preferably, the connecting member connects an outer peripheral portion of the first eccentric unit with an outer peripheral portion of the second eccentric unit. (This is a second aspect.)

Furthermore, preferably, the eccentric shaft portion passes through and supports only the first eccentric unit out of the first eccentric unit and the second eccentric unit. (This is a third aspect.)

In order to attain the above object, according to an aspect of the present invention, there is provided a transmission device comprising: a first transmission member rotatable on a first axis; an eccentric shaft including a main shaft portion rotatable on the first axis and an eccentric shaft portion disposed on a second axis disposed eccentrically with respect to the first axis; a second transmission member disposed adjacent to the first transmission member and rotatably supported by the eccentric shaft portion; a third transmission member disposed adjacent to the second transmission member and rotatable on the first axis; a first speed change mechanism that transmits torque, while changing speeds between the first and second transmission members; a second speed change mechanism that transmits torque, while changing speeds between the second and third transmission members; and a counterweight that is fixedly attached to the main shaft portion in a space which the main shaft portion of the second transmission member faces and that is disposed so as to have a center of gravity having a phase opposite to a phase of an integrated center of gravity of the eccentric shaft portion and the second transmission member to thereby revolve about the first axis, wherein a radius of rotation about the first axis of a center of gravity of the counterweight is greater than a radius of rotation about the first axis of the integrated center of gravity of the eccentric shaft portion and the second transmission member. (This is a fourth aspect.)

Further, preferably, the second transmission member and the counterweight are formed such that an offset amount along the first axis between the center of gravity of the counterweight and the integrated center of gravity of the eccentric shaft portion and the second transmission member is zero. (This is a fifth aspect.)

Furthermore, preferably, the second transmission member includes: a first half unit rotatably supported on the eccentric shaft portion; and a second half unit that is disposed adjacent to the first half unit across the space and that is to be connected with the first half unit, the first speed change mechanism being disposed between the first transmission member and the first half unit, and the second speed change mechanism being disposed between the second half unit and the third transmission member. (This is a sixth aspect.)

### Effects of the Invention

In accordance with the first aspect of the present invention, the transmission device includes the first rotation transmission member and the second rotation transmission member, the eccentric shaft, the first eccentric unit, the second eccentric unit, and the counterweight. The first rotation transmission member and the second rotation transmission member are capable of relative rotation about the first rotary axis. The eccentric shaft includes the main shaft portion on the first rotary axis and the eccentric shaft portion on the second rotary axis disposed eccentrically with respect to the first rotary axis, and the eccentric shaft portion is capable of revolving about the first rotary axis. The first eccentric unit is supported rotatably on the eccentric shaft portion, is capable of revolving about the first rotary axis while rotating around the second rotary axis, and is capable of mutually transmitting rotation with the first rotation transmission member. The second eccentric unit is connected with the first eccentric unit via the connecting member, is capable of revolving about the first rotary axis while rotating, integrally with the first eccentric unit, around the second rotary axis, and is capable of mutually transmitting rotation with the second rotation transmission member. The counterweight is disposed between the first eccentric unit and the second eccentric unit, and is incapable of relative rotation with respect to the eccentric shaft. Thus, eccentric loading that may occur in the eccentric shaft can be canceled by the counterweight and whirling can be prevented, so that the eccentric shaft can be steadily rotated. Additionally, the counterweight is disposed between the first eccentric unit and the second eccentric unit that rotates integrally with the first eccentric unit. Even if at least one of the first eccentric unit and the second eccentric unit includes a plurality of intermediate members having orbits restricted by the groove portion, interference of the counterweight disposed between the first eccentric unit and the second eccentric unit with the intermediate members disposed at the outer lateral side of the first eccentric unit and the second eccentric unit can be avoided. Thus, the counterweight can be disposed to be spaced a great distance in a radial direction away from the first rotary axis. Thus, an orbit of the counterweight as viewed from the first rotary axis direction can be disposed outside orbits of the intermediate members, or only a part of the orbit of the counterweight can be disposed to overlap the orbits of the intermediate members. Thus, moment balance with the eccentric shaft can be easily achieved even with a counterweight that is light in weight. This enables reduction in weight of the transmission device.

In accordance with the second aspect of the present invention, the connecting member connects the outer peripheral portion of the first eccentric unit with the outer peripheral portion of the second eccentric unit. A sufficient rotation space for the counterweight can be provided between the first eccentric unit and the second eccentric unit.

In accordance with the third aspect of the present invention, the eccentric shaft portion passes through to support only the first eccentric unit out of the first eccentric unit and the second eccentric unit. This allows a recessed groove to be formed or a wall to be thinned in a space that is not usable when the eccentric shaft portion passes through the second eccentric unit. Reduction in size and weight of the transmission device can thus be easily achieved.

In accordance with the fourth aspect of the present invention, a transmission device includes the first transmission member, the eccentric shaft, the second transmission member, the third transmission member, the first speed change mechanism, the second speed change mechanism, and the counterweight. The first transmission member is rotatable on the first axis. The eccentric shaft includes the main shaft portion rotatable on the first axis and the eccentric shaft portion disposed on the second axis disposed eccentrically with respect to the first axis. The second transmission member is disposed adjacent to the first transmission member and is rotatably supported by the eccentric shaft portion. The third transmission member is disposed adjacent to the second transmission member and is rotatable on the first axis. The first speed change mechanism transmits torque, while changing speeds between the first transmission member and the second transmission member. The second speed change mechanism transmits torque, while changing speeds between the second transmission member and the third transmission member. The counterweight is fixedly attached to the main shaft portion in the space which the main shaft portion of the second transmission member faces and is disposed so as to have the center of gravity having a phase opposite to the phase of the integrated center of gravity of the eccentric shaft portion and the second transmission member to thereby revolve about the first axis. In the transmission device, the radius of rotation about the first axis of the center of gravity of the counterweight is greater than the radius of rotation about the first axis of the integrated center of gravity of the eccentric shaft portion and the second transmission member. While reduction in weight of the counterweight, and of the transmission device is being achieved, a centrifugal force acting on the integrated center of gravity of the eccentric shaft portion and the second transmission member is balanced with a centrifugal force acting on the center of gravity of the counterweight. Occurrence of vibration caused by eccentric rotation of the eccentric shaft portion and the second transmission member can thereby be prevented. Furthermore, the counterweight is disposed inside the second transmission member that revolves about the first axis with the eccentric shaft portion. The center of gravity of the counterweight thus can bring an offset amount along the first axis to zero or close to zero with respect to the integrated center of gravity of the eccentric shaft portion and the second transmission member. Thus, a couple that occurs as caused by the centrifugal forces acting on the two centers of gravity can be brought to zero or close to zero, and occurrence of vibration caused by the couple can also be prevented.

In accordance with the fifth aspect of the present invention, the second transmission member and the counterweight are formed such that the offset amount along the first axis between the center of gravity of the counterweight and the integrated center of gravity of the eccentric shaft portion and the second transmission member is zero. A couple that otherwise occurs as caused by the centrifugal forces acting on the center of gravity of the counterweight and the integrated center of gravity of the eccentric shaft portion and the second transmission member can be zeroed.

In accordance with the sixth aspect of the present invention, an extent of the space in which the counterweight is housed can be freely set in accordance with the size of the counterweight by selecting an interval across which the first half unit is disposed adjacent to the second half unit of the second transmission member. Distribution of weight between the first half unit and the second half unit allows the position of the integrated center of gravity of the eccentric shaft portion and the second transmission member along the first axis to be readily adjusted. Thus, the offset amount along the first axis of the integrated center of gravity of the eccentric shaft portion and the second transmission member with respect to the center of gravity of the counterweight can be readily set to zero. Moreover, the second transmission member is separated into the first half unit and the second half unit and the first speed change mechanism is disposed between the first transmission member and the first half unit of the second transmission member, and the second speed change mechanism is disposed between the second half unit of the second transmission member and the third transmission member. This arrangement enables the first speed change mechanism to be manufactured independently of the second speed change mechanism before assembly, so that productivity of the transmission device can be enhanced.

### BRIEF DESCRIPTION OF DRAWINGS

FIG. 1 is a longitudinal cross-sectional front view of a transmission device according to a first embodiment of the present invention. (first embodiment)

FIG. 2 is a schematic view of the transmission device in FIG. 1. (first embodiment)

FIG. 3 is a cross-sectional view from arrowed line A3-A3 in FIG. 1. (first embodiment)

FIG. 4 is a cross-sectional view from arrowed line A4-A4 in FIG. 1. (first embodiment)

FIG. 5 is a cross-sectional view from arrowed line A5-A5 in FIG. 1. (first embodiment)

### EXPLANATION OF REFERENCE NUMERALS AND SYMBOLS

1 First rotation transmission member (first transmission member, differential case)

2c Groove portion (trochoid wave groove)

8 Eccentric shaft

8a Main shaft portion

8b Eccentric shaft portion

10 First eccentric unit (first half unit)

10b Groove portion (trochoid wave groove)

11 Connecting member

12 Second eccentric unit (second half unit)

12b Groove portion (trochoid wave groove)

13 Counterweight

15 Second rotation transmission member (third transmission member)

15c Groove portion (trochoid wave groove)

19 Intermediate member (first rolling element)

21 Intermediate member (second rolling element)

22 Second transmission member

G1 Integrated center of gravity of eccentric shaft portion and second transmission member

G2 Center of gravity of counterweight

R1 Radius of rotation about first axis of integrated center of gravity of eccentric shaft portion and second transmission member

R2 Radius of rotation about first axis of center of gravity of counterweight

S Space

T1 First speed change mechanism

T2 Second speed change mechanism

X1 First rotary axis (first axis)

X2 Second rotary axis (second axis)

### MODES FOR CARRYING OUT THE INVENTION

Modes for carrying out the present invention are explained below by reference to the attached drawings.

### First Embodiment

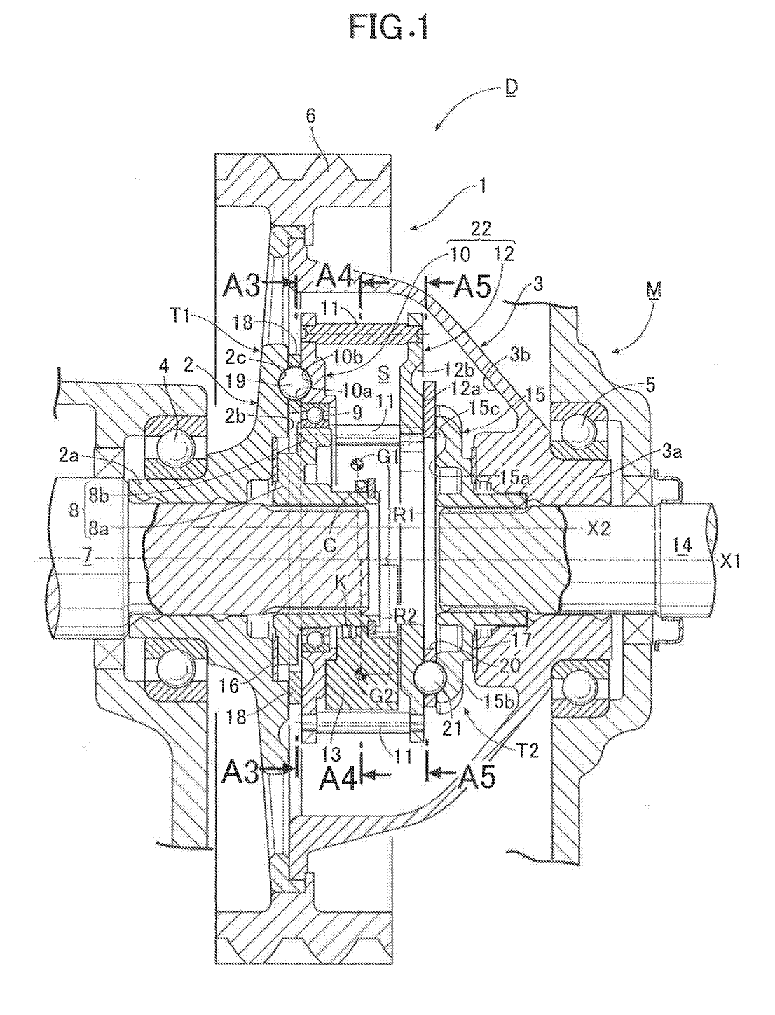

FIGS. 1 to 5 illustrate a transmission device according to a first embodiment of the present invention, applied as a differential device.

The transmission device according to the first embodiment is housed as a differential device D in an automotive transmission case M in FIG. 1. The transmission device includes a differential case 1 as a first rotation transmission member. The differential case 1 includes a first case half unit 2 and a second case half unit 3.

In FIG. 1, the first case half unit 2 and the second case half unit 3 of the differential case 1 have a first boss portion 2a and a second boss portion 3a, respectively, formed into a cylindrical shape. The first boss portion 2a and the second boss portion 3a each have an axis center extending along a first rotary axis (first axis) X1. Additionally, the first boss portion 2a and the second boss portion 3a have outer peripheries mounted in the transmission case M via a first bearing 4 and a second bearing 5, respectively. The first case half unit 2 has an outer peripheral portion connected with an outer peripheral portion of the second case half unit 3. A ring gear 6 is integrally coupled with an outer periphery of the connection between the first case half unit 2 and the second case half unit 3. The ring gear 6 is connected with a drive source not depicted and a rotational force transmitted from the drive source to the ring gear 6 causes the differential case 1 to rotate about the first rotary axis X1.

An eccentric shaft 8, a first eccentric unit 10, a second eccentric unit 12, a counterweight 13, and a second rotation transmission member 15 are housed in the differential case 1. Specifically, the eccentric shaft 8 includes a main shaft portion 8a and an eccentric shaft portion 8b. The main shaft portion 8a is splined to a first rotary shaft 7 that is passed through the first boss portion 2a. The main shaft portion 8a is rotatable about the first rotary axis X1. The eccentric shaft portion 8b is disposed on a second rotary axis (second axis) X2 that is eccentric with respect to the first rotary axis X1. The first eccentric unit 10 is rotatably supported on an outer periphery of the eccentric shaft portion 8b via a third bearing 9 so as to have one side surface 10a facing an inner lateral surface 2b of the first case half unit 2 of the differential case 1. The second eccentric unit 12 is integrally connected with the first eccentric unit 10 via bar-shaped connecting members 11 so as to be spaced away from the other side surface of the first eccentric unit 10. The counterweight 13 is disposed between the first eccentric unit 10 and the second eccentric unit 12 to be incapable of relative rotation with respect to the eccentric shaft 8. The second rotation transmission member 15 is splined to a second rotary shaft 14 that is passed through the second boss portion 3a so as to be rotatable about the first rotary axis X1. The second rotation transmission member 15 has one side surface 15a facing an outer lateral surface 12a of the second eccentric unit 12.

A first thrust washer 16 is disposed between the inner lateral surface 2b of the first case half unit 2 of the differential case 1 and the eccentric shaft 8. A second thrust washer 17 is disposed between an inner lateral surface 3b of the second case half unit 3 of the differential case 1 and the other side surface 15b of the second rotation transmission member 15.

In the first embodiment, the counterweight 13 is connected with the main shaft portion 8a of the eccentric shaft 8 via a key K and a clip C as to be incapable of relative rotation. The connection between the counterweight 13 and the eccentric shaft 8 is, however, not limited to this arrangement.

The connecting members 11 connect an outer peripheral portion of the first eccentric unit 10 with an outer peripheral portion of the second eccentric unit 12 so as to allow for a sufficient rotating space for the counterweight 13 between the first eccentric unit 10 and the second eccentric unit 12. The positions at which the connecting members 11 connect the first eccentric unit 10 with the second eccentric unit 12 are not limited to this arrangement.

Additionally, the eccentric shaft portion 8b passes through to support only the first eccentric unit 10 out of the first eccentric unit 10 and the second eccentric unit 12 in order for a cutout portion, etc. to be formed in a space at a central portion of the second eccentric unit 12. The eccentric shaft portion 8b may be formed to pass through the second eccentric unit 12.

Additionally, a first speed change mechanism T1, for example, is disposed between the differential case 1 and the first eccentric unit 10 adjacent the differential case 1. The first speed change mechanism T1 transmits torque, while changing speeds between the differential case 1 and the first eccentric unit 10. In addition, a second speed change mechanism T2, for example, is disposed between the second eccentric unit 12 and the second rotation transmission member 15 adjacent the second eccentric unit 12. The second speed change mechanism T2 transmits torque, while changing speeds between the second eccentric unit 12 and the second rotation transmission member 15. When the differential case 1 is a first transmission member and the second rotation transmission member 15 is a third transmission member, for example, the first eccentric unit 10 and the second eccentric unit 12 form as a whole a second transmission member 22 that transmits torque, while changing speeds between the differential case 1 as the first transmission member and the second rotation transmission member 15 as the third transmission member. The first eccentric unit 10 and the second eccentric unit 12 form a first half unit and a second half unit, respectively, of the second transmission member 22.

The first speed change mechanism T1 and the second speed change mechanism T2 will be described below.

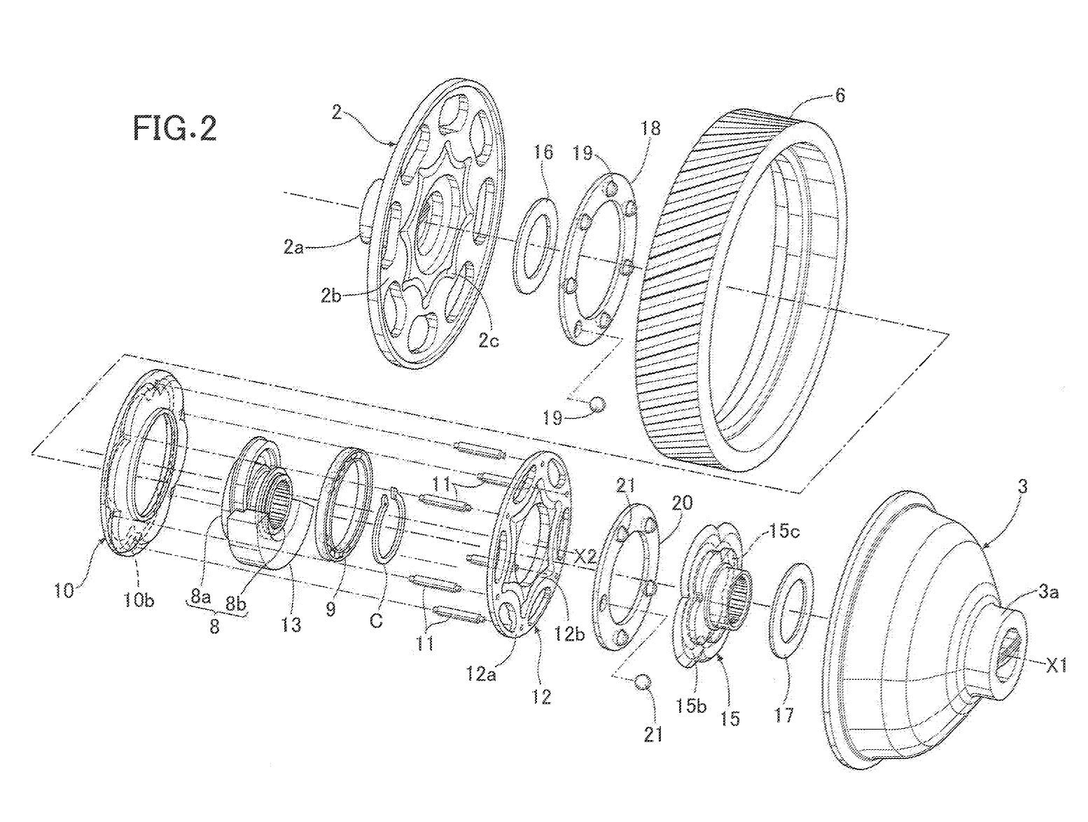

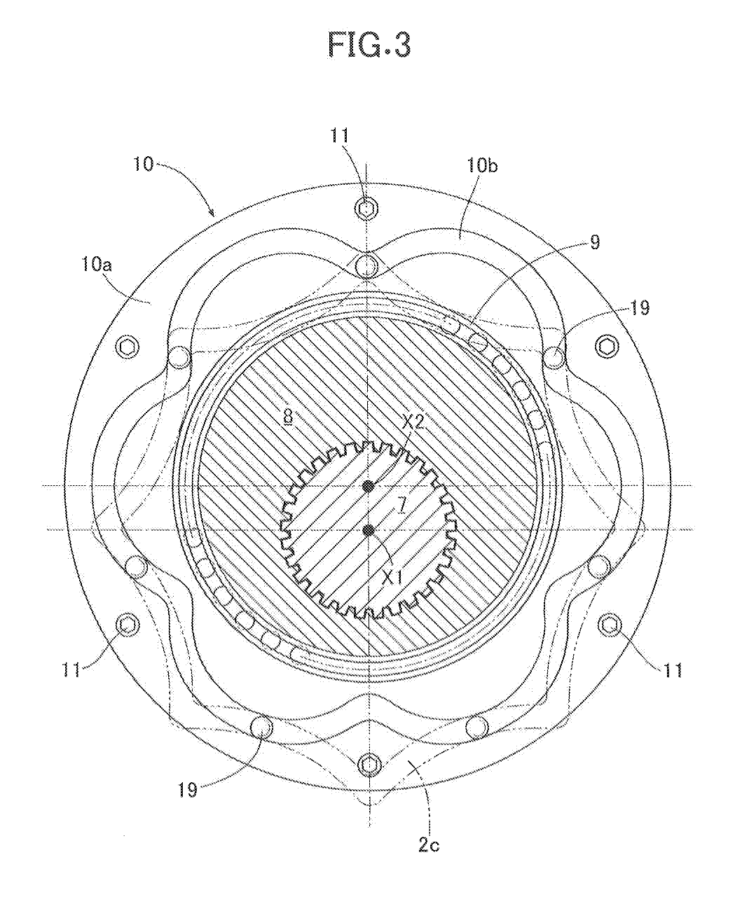

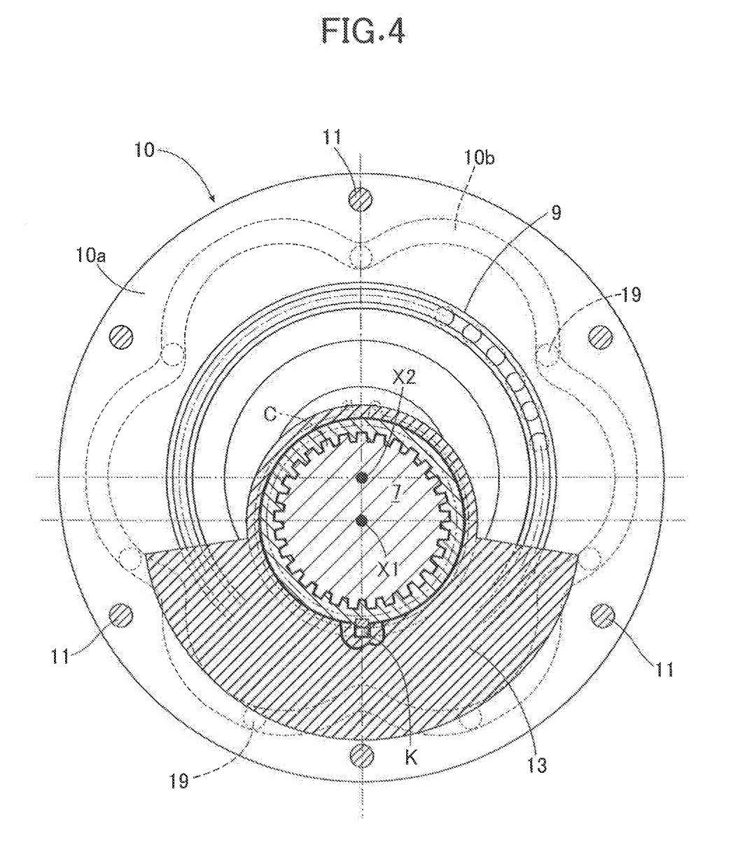

Reference is also made to FIG. 2 as a schematic view, FIG. 3 as a cross-sectional view from arrowed line A3-A3 in FIG. 1, and FIG. 4 as a cross-sectional view from arrowed line A4-A4 in FIG. 1. The inner lateral surface 2b of the first case half unit 2 has eight waves of a hypotrochoid wave groove (groove portion) 2c formed around the first rotary axis X1. The one side surface 10a of the first eccentric unit 10 facing the hypotrochoid wave groove 2c has six waves of an epitrochoid wave groove (groove portion) 10b formed around the second rotary axis X2. In addition, a plurality of ball-shaped first rolling elements (intermediate members) 19 retained in a first race member 18 are disposed between the hypotrochoid wave groove 2c and the epitrochoid wave groove 10b at an intersection between the hypotrochoid wave groove 2c and the epitrochoid wave groove 10b. The first rolling elements 19 are sandwiched between the hypotrochoid wave groove 2c and the epitrochoid wave groove 10b and are disposed therebetween so as to move along an orbit defined by the hypotrochoid wave groove 2c and the epitrochoid wave groove 10b. Thus, when the first rotary shaft 7 is rotated with the differential case 1 fixed, the first eccentric unit 10 on the eccentric shaft portion 8b also rotates in a manner of being operatively associated with rotation of the eccentric shaft portion 8b of the eccentric shaft 8 about the first rotary axis X1. At this time, an opposing position of the hypotrochoid wave groove 2c and the epitrochoid wave groove 10b moves, resulting in the first rolling elements 19 sandwiched between the hypotrochoid wave groove 2c and the epitrochoid wave groove 10b moving and rotating, so that the first rolling elements 19 cause the first eccentric unit 10 to revolve about the first rotary axis X1 while rotating around the second rotary axis X2. The hypotrochoid wave groove 2c, the epitrochoid wave groove 10b and the first rolling elements 19 form the first speed change mechanism T1 that transmits torque, while changing speeds between, for example, the differential case 1 and the first eccentric unit 10.

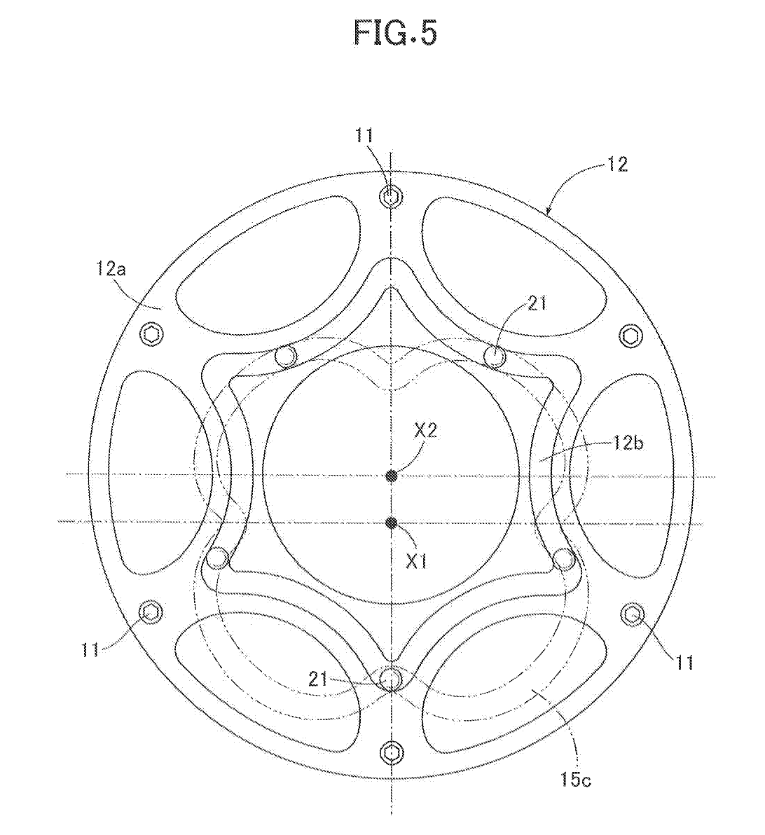

Reference is also made to FIG. 5 as a cross-sectional view from arrowed line A5-A5 in FIG. 1. The outer lateral surface 12a of the second eccentric unit 12 has six waves of a hypotrochoid wave groove (groove portion) 12b formed around the second rotary axis X2. The one side surface 15a of the second rotation transmission member 15 facing the hypotrochoid wave groove 12b has four waves of an epitrochoid wave groove (groove portion) 15c formed around the first rotary axis X1. In addition, a plurality of ball-shaped second rolling elements (intermediate members) 21 retained in a second race member 20 are disposed between the hypotrochoid wave groove 12b and the epitrochoid wave groove 15c at an intersection between the hypotrochoid wave groove 12b and the epitrochoid wave groove 15c. The second rolling elements 21 are sandwiched between the hypotrochoid wave groove 12b and the epitrochoid wave groove 15c and are disposed therebetween so as to move along an orbit defined by the hypotrochoid wave groove 12b and the epitrochoid wave groove 15c. Thus, when the second eccentric unit 12 revolves about the first rotary axis X1 while rotating around the second rotary axis X2 in a manner of being operatively associated with orbital revolution of the first eccentric unit 10 about the first rotary axis X1 with concurrent axial rotation of the first eccentric unit 10 about the second rotary axis X2, the second rolling elements 21 sandwiched between the hypotrochoid wave groove 12b and the epitrochoid wave groove 15c move and rotate as an opposing position of the hypotrochoid wave groove 12b and the epitrochoid wave groove 15c moves. The foregoing results in the second rotation transmission member 15 rotating about the first rotary axis X1 and the rotation of the second rotation transmission member 15 is output to the second rotary shaft 14. The hypotrochoid wave groove 12b, the epitrochoid wave groove 15c and the second rolling elements 21 form the second speed change mechanism T2 that transmits torque, while changing speeds between, for example, the second eccentric unit 12 and the second rotation transmission member 15.

Eccentric loading on the eccentric shaft 8 occurring as a result of orbital revolution of the eccentric shaft portion 8b of the eccentric shaft 8, the first eccentric unit 10 and the second eccentric unit 12 about the first rotary axis X1 is canceled by the counterweight 13 that is incapable of relative rotation with respect to the eccentric shaft 8 and that is disposed at the eccentric shaft 8. The counterweight 13 is fixedly attached to the main shaft portion 8a of the eccentric shaft 8 in a space S that is formed between the first eccentric unit 10 and the second eccentric unit 12 and which the main shaft portion 8a of the eccentric shaft 8 faces so as to have a center of gravity G2 having a phase opposite to a phase of an integrated center of gravity G1 of the eccentric shaft portion 8b of the eccentric shaft 8, the first eccentric unit 10 and the second eccentric unit 12.

The foregoing arrangement allows the counterweight 13 to avoid interference with the first rolling elements 19 or the second rolling elements 21 and to be spaced a great distance in the radial direction away from the first rotary axis X1. Thus, an orbit of the counterweight 13 as viewed from the first rotary axis X1 direction can be disposed outside orbits of the first rolling elements 19 and the second rolling elements 21, or only a part of the orbit of the counterweight 13 can be disposed to overlap the orbits of the first rolling elements 19 and the second rolling elements 21.

A radius of rotation R2 about the first rotary axis X1 of the center of gravity G2 of the counterweight 13 is greater than, for example, a radius of rotation R1 about the first rotary axis X1 of the integrated center of gravity G1 of the eccentric shaft portion 8b, the first eccentric unit 10 and the second eccentric unit 12. Additionally, an offset amount along the first rotary axis X1 between the center of gravity G2 of the counterweight 13 and the integrated center of gravity G1 of the eccentric shaft portion 8b, the first eccentric unit 10 and the second eccentric unit 12 is formed to, for example, be zero or close to zero. The counterweight 13 may even be formed to have an outermost peripheral surface thereof close to the connecting members 11. This arrangement enables an increased maximum radius of the counterweight 13 and thus, an increased radius of rotation R2 of the counterweight 13, so that further reduction in weight of the counterweight 13 can be achieved.

Let Z1 be the number of waves of the hypotrochoid wave groove 2c of the inner lateral surface 2b of the first case half unit 2, Z2 be the number of waves of the epitrochoid wave groove 10b of the one side surface 10a of the first eccentric unit 10, Z3 be the number of waves of the hypotrochoid wave groove 12b of the outer lateral surface 12a of the second eccentric unit 12, and Z4 be the number of waves of the epitrochoid wave groove 15c of the one side surface 15a of the second rotation transmission member 15. Then, a transmission ratio between the first rotary shaft 7 and the second rotary shaft 14 with the differential case 1 fixed is given by the following expression: [1−{(Z1×Z3)/(Z2×Z4)}]. In the first embodiment, Z1=8, Z2=6, Z3=6, and Z4=4, and a reduction ratio when the first rotary shaft 7 is an input shaft is −1. Thus, one complete rotation of the first rotary shaft 7 results in minus one complete rotation of the second rotary shaft 14.

Thus, n complete rotation of the first rotary shaft 7 with the differential case 1 fixed results in n complete reverse rotation of the second rotary shaft 14. Under this condition, applying a rotational force from the drive source to the ring gear 6 to thereby rotate the differential case 1 causes the first rotary shaft 7 to rotate at a rotation speed higher by n than a rotation speed of the differential case 1 and causes the second rotary shaft 14 to rotate at a rotation speed lower by n than the rotation speed of the differential case 1. Thus, equal differential rotation can be achieved in which an increase in the rotation speed of the output shaft on one side is equalized with a decrease in the rotation speed of the output on the other side. When the first rotary shaft 7 and the second rotary shaft 14 rotate at an identical rotation speed, the rotation speed of the first rotary shaft 7 and the second rotary shaft 14 is equal to the rotation speed of the differential case 1, so that the first rotary shaft 7 and the second rotary shaft 14 rotate integrally with the differential case 1. Thus, the transmission device can be used as a differential device by selecting the number of waves of the wave grooves so as to achieve a transmission ratio of −1 as in the first embodiment.

Operation of the first embodiment will be described below.

The differential device D includes the differential case (first rotation transmission member, first transmission member) 1 that is capable of relative rotation about the first rotary axis (first axis) X1. The eccentric shaft 8, the first eccentric unit 10, the second eccentric unit 12 and the counterweight 13 are housed in the differential case 1. The eccentric shaft 8 includes the main shaft portion 8a rotatable about the first rotary axis X1 and the eccentric shaft portion 8b disposed on the second rotary axis (second axis) X2 that is eccentric with respect to the first rotary axis X1. The first eccentric unit 10 is rotatably supported on the outer periphery of the eccentric shaft portion 8b so as to have the one side surface 10a facing the inner lateral surface 2b of the first case half unit 2. The second eccentric unit 12 is integrally connected with the first eccentric unit 10 via the connecting members 11 so as to be spaced away from the first eccentric unit 10. The counterweight 13 is disposed between the first eccentric unit 10 and the second eccentric unit 12 to be incapable of relative rotation with respect to the eccentric shaft 8. Thus, the eccentric loading occurring from the orbital revolution of the eccentric shaft 8 about the first rotary axis X1 of the eccentric shaft portion 8b can be canceled by the counterweight 13. This eliminates occurrence of whirling of the eccentric shaft 8 even when the eccentric loading occurs on the eccentric shaft 8, so that the eccentric shaft 8 can be steadily rotated.

The inner lateral surface 2b of the first case half unit 2 has formed the hypotrochoid wave groove 2c having eight waves, while the one side surface 10a of the first eccentric unit 10 facing the hypotrochoid wave groove 2c has formed the epitrochoid wave groove 10b having six waves. In addition, the first rolling elements 19 are disposed between the hypotrochoid wave groove 2c and the epitrochoid wave groove 10b, and the outer lateral surface 12a of the second eccentric unit 12 has formed the hypotrochoid wave groove 12b having six waves and the one side surface 15a of the second rotation transmission member 15 facing the hypotrochoid wave groove 12b has formed the epitrochoid wave groove 15c having four waves. The second rolling elements 21 are disposed between the hypotrochoid wave groove 12b and the epitrochoid wave groove 15c. Disposing the counterweight 13 spaced away in the radial direction from the first rotary axis X1, as attempted to avoid interference with the first rolling elements 19 and the second rolling elements 21, was conventionally a difficult task to achieve. In the first embodiment, however, the counterweight 13 is disposed between the first eccentric unit 10 and the second eccentric unit 12, in which the counterweight 13 is free from interference with the first rolling elements 19 and the second rolling elements 21, so that the counterweight 13 can be spaced a great distance away in the radial direction from the first rotary axis X1.

Thus, in the first embodiment, the orbit of the counterweight 13 as viewed from the first rotary axis X1 direction can be disposed outside the orbits of the first rolling elements 19 and the second rolling elements 21, or only a part of the orbit of the counterweight 13 can be disposed to overlap the orbits of the first rolling elements 19 and the second rolling elements 21. Thus, moment balance with the eccentric shaft 8 can be easily achieved even with a counterweight 13 that is light in weight. This enables reduction in weight of the differential device (transmission device) D housed inside an automobile.

The differential device D does not include a bevel gear or a center plate and is thus not large in the axial direction. Additionally, the trochoid wave grooves 10b and 12b are formed on only one lateral side of the two lateral sides of each of the first and second eccentric units 10 and 12, respectively. Specifically, the trochoid wave groove is not formed on opposite sides of a single eccentric unit. This facilitates formation of the trochoid wave groove and reduces work processes involved.

The connecting members 11 connect the outer peripheral portion of the first eccentric unit 10 with the outer peripheral portion of the second eccentric unit 12, so that a sufficient rotation space for the counterweight 13 can be provided between the first eccentric unit 10 and the second eccentric unit 12.

Additionally, the eccentric shaft portion 8b passes through to support only the first eccentric unit 10 out of the first eccentric unit 10 and the second eccentric unit 12. This allows a cutout or a recessed groove to be formed, or a wall is thinned, in a space that is not usable when the eccentric shaft portion 8b passes through the second eccentric unit 12. This readily achieves reduction in size and weight of the transmission device (differential device).

The counterweight 13 is fixedly attached to the main shaft portion 8a of the second transmission member 22 in the space S which the main shaft portion 8a faces and is disposed so as to have the center of gravity G2 having a phase opposite to the phase of the integrated center of gravity G1 of the eccentric shaft portion 8b and the second transmission member 22 to thereby rotate about the first axis X1. The radius of rotation R2 about the first axis X1 of the center of gravity G2 of the counterweight 13 is greater than the radius of rotation R1 about the first rotary axis X1 of the integrated center of gravity G1 of the eccentric shaft portion 8b and the second transmission member 22. While reduction in weight of the counterweight 13, and of the differential device (transmission device) D is being achieved, a centrifugal force acting on the integrated center of gravity G1 of the eccentric shaft portion 8b and the second transmission member 22 is balanced with a centrifugal force acting on the center of gravity G2 of the counterweight 13. Occurrence of vibration caused by eccentric rotation of the eccentric shaft portion 8b and the second transmission member 22 can thereby be prevented. Furthermore, the counterweight 13 is disposed inside the second transmission member 22 that revolves about the first axis X1 with the eccentric shaft portion 8b. The center of gravity G2 of the counterweight 13 thus can bring the offset amount along the first axis X1 to zero or close to zero with respect to the integrated center of gravity G1 of the eccentric shaft portion 8b and the second transmission member 22. Thus, a couple that occurs as caused by the centrifugal forces acting on the centers of gravity G1 and G2 can be brought to zero or close to zero and occurrence of vibration caused by the couple can also be prevented.

Additionally, the arrangement in which the offset amount along the first axis X1 between the center of gravity G2 of the counterweight 13 and the integrated center of gravity G1 of the eccentric shaft portion 8b and the second transmission member 22 is zero allows the couple that otherwise occurs as caused by the centrifugal forces acting on the center of gravity G2 of the counterweight 13 and the integrated center of gravity G1 of the eccentric shaft portion 8b and the second transmission member 22 to be zero.

An extent of the space in which the counterweight 13 is housed can be freely set in accordance with the size of the counterweight 13 by selecting an interval across which the first half unit (first eccentric unit) 10 of the second transmission member 22 is disposed adjacent to the second half unit (second eccentric unit) 12 of the second transmission member 22. Distribution of weight between the first half unit 10 and the second half unit 12 allows the position of the integrated center of gravity G1 of the eccentric shaft portion 8b and the second transmission member 22 along the first axis X1 to be readily adjusted. Thus, the offset amount along the first axis X1 of the integrated center of gravity GI of the eccentric shaft portion 8b and the second transmission member 22 with respect to the center of gravity G2 of the counterweight 13 can be readily set to zero. Moreover, the second transmission member 22 is separated into the first half unit 10 and the second half unit 12, and the first speed change mechanism T1 is disposed between the first transmission member 1 and the first half unit 10 of the second transmission member 22 and the second speed change mechanism T2 is disposed between the second half unit 12 of the second transmission member 22 and the third transmission member 15. This arrangement enables the first speed change mechanism T1 to be manufactured independently of the second speed change mechanism T2 before assembly, so that productivity of the differential device (transmission device) D can be enhanced.

The first half unit 10 and the second half unit 12 of the second transmission member 22 are connected with each other via the connecting members 11 that are disposed annularly on the outside in the radial direction of the first speed change mechanism T1 and the second speed change mechanism T2. This arrangement enables easy connection between the first half unit 10 and the second half unit 12 without allowing the first speed change mechanism T1 and the second speed change mechanism T2 to serve as a hindrance or without deforming, damaging, or otherwise causing a defect on the first speed change mechanism T1 and the second speed change mechanism T2. The counterweight 13 is formed to have the outermost peripheral surface thereof close to the connecting members 11. This arrangement enables an increased maximum radius of the counterweight 13 and thus, an increased radius of rotation R2 of the counterweight 13, so that further reduction in weight of the counterweight 13 can be achieved.

### Second Embodiment

A second embodiment of the present invention will be described below.

The second embodiment of the present invention is arranged as follows. Specifically, the first rotation transmission member 1 of the transmission device of the present invention is fixed to be incapable of rotation and one of the first rotary shaft 7 and the second rotary shaft 14 is defined as an input shaft of rotating torque and the other of the first rotary shaft 7 and the second rotary shaft 14 is defined as an output shaft of the rotating torque, to thereby enable transmission of the rotating torque input from the input shaft to the output shaft with reduced or increased speed. Specifically, the differential case 1 in the first embodiment is removed from the transmission case M and the differential case 1 is fixed to be incapable of rotation. Either one of the first rotary shaft 7 and the second rotary shaft 14 is defined as the input shaft and the other one of the first rotary shaft 7 and the second rotary shaft 14 is defined as the output shaft. Further description with reference to drawings will be omitted.

Operation of the second embodiment will be described below.

Also in the second embodiment, the counterweight 13 is disposed between the first eccentric unit 10 and the second eccentric unit 12 that do not interfere with the first rolling elements 19 and the second rolling elements 21 as the intermediate members. This arrangement enables the counterweight 13 to be spaced a great distance apart in the radial direction from the first rotary axis X1. Thus, an orbit of the counterweight 13 as viewed from the first rotary axis X1 direction can be disposed outside orbits of the first rolling elements 19 and the second rolling elements 21, or only a part of the orbit of the counterweight 13 can be disposed to overlap the orbits of the first rolling elements 19 and the second rolling elements 21. This allows moment balance with the eccentric shaft 8 to be readily achieved even with a light counterweight 13, so that reduction in weight of the transmission device can be achieved.

The embodiments of the present invention have been explained above, but the present invention is not limited to the above embodiments and may be modified in a variety of ways as long as the modifications do not depart from the spirit and scope thereof.

For example, although the groove portion is specifically the trochoid wave groove in the first and second embodiments, the present invention is not limited to the trochoid wave groove. The groove portion may be, for example, a cycloid wave groove, etc.

Additionally, although in the first and second embodiments, the first rolling elements 19 and the second rolling elements 21 as the intermediate members are each formed into a ball shape, the present invention is not limited to this shape. The first rolling elements 19 and the second rolling elements 21 may each be a roller shape or a pin shape.

In the first and second embodiments, the groove portions are formed in the opposing surfaces of the first case half unit 2 and the first eccentric unit 10 as a first rotation transmission portion and in the opposing surfaces of the second eccentric unit 12 and the second rotation transmission member 15 as a second rotation transmission portion. The arrangement is, however, illustrative only and not limiting. For example, one of the rotation transmission portions may be wave grooves formed in the outer periphery and the inner periphery of the two rotary units or engagement of gears or any forms other than the groove portions.

Additionally, the groove portion does not necessarily have to be the wave groove. The groove portion may be a simple circular groove and the intermediate member may be a cylindrical body that bulges from one side surface of one rotary unit into the circular groove. The rotation transmission portion may then be formed as an adjustment mechanism that simply takes off axial rotation and orbital revolution of the one rotary unit as rotation of the other rotary unit.

Additionally, the connecting members 11 is not limited to a bar shape. For example, the connecting members 11 may be leg portions having an annular ring shape or an arcuate shape as viewed from the second rotary axis X2 direction. Alternatively, either one of the first eccentric unit 10 and the second eccentric unit 12 may be provided with an annular ring-shaped connecting member that is to be placed over the other as a lid, and the first eccentric unit 10 may then be engaged with, or welded to, the second eccentric unit 12.

In the first embodiment, the differential device D is housed in the transmission case M in an automobile. The differential device D is not, however, limited only to the differential device in automobiles.

In the second embodiment, rotation input from the first rotary shaft 7 is formed to be output from the second rotary shaft 14. Such arrangement that rotation input from the second rotary shaft 14 is to be output from the first rotary shaft 7 is possible.

1. A transmission device comprising:
a first rotation transmission member and a second rotation transmission member which are capable of relative rotation about a first rotary axis;
an eccentric shaft including a main shaft portion on the first rotary axis and an eccentric shaft portion on a second rotary axis disposed eccentrically with respect to the first rotary axis, the eccentric shaft portion being capable of revolving about the first rotary axis;
a first eccentric unit supported rotatably on the eccentric shaft portion, the first eccentric unit being capable of revolving about the first rotary axis while rotating around the second rotary axis and being capable of mutually transmitting rotation between the first eccentric unit and the first rotation transmission member;
a second eccentric unit connected with the first eccentric unit via a connecting member, the second eccentric unit being capable of revolving about the first rotary axis while rotating, integrally with the first eccentric unit, around the second rotary axis and being capable of mutually transmitting rotation between the second eccentric unit and the second rotation transmission member; and
a counterweight disposed between the first eccentric unit and the second eccentric unit, the counterweight being incapable of relative rotation with respect to the eccentric shaft, wherein
at least one of the first rotation transmission member and the first eccentric unit or of the second rotation transmission member and the second eccentric unit has a groove portion formed in at least one of two opposing surfaces thereof and includes a plurality of intermediate members having orbits restricted by the groove portion, and
the counterweight has an orbit disposed, when viewed from a direction of the first rotary axis, outside the orbits of the intermediate members or has only a part of the orbit disposed to overlap the orbits of the intermediate members.

2. The transmission device according to claim 1, wherein the connecting member connects an outer peripheral portion of the first eccentric unit with an outer peripheral portion of the second eccentric unit.

3. The transmission device according to claim 1, wherein the eccentric shaft portion passes through and supports only the first eccentric unit out of the first eccentric unit and the second eccentric unit.

4. A transmission device comprising:
a first transmission member rotatable on a first axis;
an eccentric shaft including a main shaft portion rotatable on the first axis and an eccentric shaft portion disposed on a second axis disposed eccentrically with respect to the first axis; a second transmission member disposed adjacent to the first transmission member and rotatably supported by the eccentric shaft portion; a third transmission member disposed adjacent to the second transmission member and rotatable on the first axis;
a first speed change mechanism that transmits torque, while changing speeds between the first and second transmission members;
a second speed change mechanism that transmits torque, while changing speeds between the second and third transmission members; and
a counterweight that is fixedly attached to the main shaft portion in a space which the main shaft portion of the second transmission member faces and that is disposed so as to have a center of gravity having a phase opposite to a phase of an integrated center of gravity of the eccentric shaft portion and the second transmission member to thereby revolve about the first axis, wherein
a radius of rotation about the first axis of a center of gravity of the counterweight is greater than a radius of rotation about the first axis of the integrated center of gravity of the eccentric shaft portion and the second transmission member.

5. The transmission device according to claim 4, wherein the second transmission member and the counterweight are formed such that an offset amount along the first axis between the center of gravity of the counterweight and the integrated center of gravity of the eccentric shaft portion and the second transmission member is zero.

6. The transmission device according to claim 4, wherein
the second transmission member includes:
a first half unit rotatably supported on the eccentric shaft portion; and
a second half unit that is disposed adjacent to the first half unit across the space and that is to be connected with the first half unit, the first speed change mechanism being disposed between the first transmission member and the first half unit, and the second speed change mechanism being disposed between the second half unit and the third transmission member.

7. The transmission device according to claim 2, wherein the eccentric shaft portion passes through and supports only the first eccentric unit out of the first eccentric unit and the second eccentric unit.

8. The transmission device according to claim 5, wherein
the second transmission member includes:
a first half unit rotatably supported on the eccentric shaft portion; and
a second half unit that is disposed adjacent to the first half unit across the space and that is to be connected with the first half unit, the first speed change mechanism being disposed between the first transmission member and the first half unit, and the second speed change mechanism being disposed between the second half unit and the third transmission member.
